(19) United States
(12) Patent Application Publication
(10) Pub. No.: US 2021/0163350 A1
(43) Pub. Date: Jun. 3, 2021

(54) PROCESS FOR THE PRODUCTION OF SINTER POWDER PARTICLES (SP) CONTAINING AT LEAST ONE REINFORCEMENT FIBER

(71) Applicant: BASF SE, Ludwigshafen am Rhein (DE)

(72) Inventors: Claus GABRIEL, Ludwigshafen am Rhein (DE); Thomas MEIER, Ludwigshafen am Rhein (DE); Natalie Beatrice Janine HERLE, Ludwigshafen am Rhein (DE); Leander VERBELEN, Heidelberg (DE); Stefan JOSUPEIT, Heidelberg (DE)

(21) Appl. No.: 17/257,345

(22) PCT Filed: Jun. 27, 2019
(86) PCT No.: PCT/EP2019/067270

§ 371 Date: Dec. 31, 2020

(30) Foreign Application Priority Data
Jul. 2, 2018 (EP) 18181242.1

(51) Int. Cl. C03C 25/328; C04B 35/532; C04B 35/524; C04B 35/515; C04B 35/14; C04B 35/16; C04B 35/628; C04B 35/626; C04B 35/634; C04B 35/64; C03C 1/02; C03C 12/00; C03B 37/16; B33Y 70/10; D01F 11/08; D01F 11/14

(52) U.S. Cl. CPC C03C 25/328; B29K 2077/00; C04B 35/524; C04B 35/515; C04B 35/14; C04B 35/16; C04B 35/62844; C04B 35/6261; C04B 35/63468; C04B 35/64; C03C 1/024; C03C 12/00; C03B 37/16; B33Y 70/10; D01F 11/08; D01F 11/14; C04B 2235/422; C04B 2235/421; C04B 2235/3418; C04B 2235/3427; C04B 2235/48; C04B 2235/52; C04B 2235/6026; C04B 2235/665; C04B 35/532

(57) ABSTRACT

A process for the production of sinter powder particles (SP), comprising the steps a) providing at least one continuous filament, b) coating, the at least one continuous filament provided in step a) with at least one thermoplastic polymer to obtain a continuous strand comprising the at least one continuous filament, coated with the at least one thermoplastic polymer, wherein the average cross-sectional diameter of the strand is in the range of 10 to 300 pm, and c) size reducing of the continuous strand provided in step b) in order to obtain the sinter powder particles (SP), wherein the average length of the sinter powder particles (SP) is in the range of 10 to 300 pm. The present invention further relates to sinter powder particles (SP) obtained by the process, the use of the sinter powder particles (SP) in a powder-based additive manufacturing process and sinter powder particles (SP) having an essentially cylindrical shape N as well as a process for the production of a shaped body by laser sintering or high-speed sintering of sinter powder particles (SP).

The present invention relates to a process for the production of sinter powder particles (SP). The sinter powder particles (SP) comprise at least one reinforcement fiber which is coated with at least one polymer. The present invention further relates to sinter powder particles (SP) obtained by the inventive process, the use of the sinter powder particles (SP) in a powder-based additive manufacturing process and sinter powder particles (SP) having an essentially cylindrical shape as well as a process for the production of a shaped body by laser sintering or high-speed sintering of sinter powder particles (SP).

The rapid provision of prototypes is a problem which has frequently occurred in recent times. One process which is particularly suitable for this so-called “rapid prototyping” is selective laser sintering (SLS). This involves selectively exposing a polymer powder in a chamber to a laser beam. The powder melts, and the molten particles coalesce and solidify again. Repeated application of polymer powder and the subsequent irradiation with a laser facilitates modeling of three-dimensional shaped bodies.

The process of selective laser sintering for the production of shaped bodies from pulverulent polymers is described in detail in patent specifications U.S. Pat. No. 6,136,948 and WO 96/06881.

In order to improve the mechanical properties of the shaped bodies produced by a powder-based additive manufacturing process, in some cases sinter powders are used which contain reinforcement materials.

WO 2018/019728 discloses a sinter powder comprising polyamide polymers and a fibrous reinforcement agent. The sinter powder is produced by grinding the polyamides and the fibrous reinforcement agent in a mill. Therefore, the polyamides and the fibrous reinforcement agent can be compounded in an extruder and subsequently ground in a mill. It is also possible to introduce the polyamides and the fibrous reinforcement agent separately into the mill in order to obtain the sinter powder. The sinter powder described in WO 2018/019728, overall, when sintered leads to shaped bodies showing good mechanical properties. However, if the fibrous reinforcement agent is dry-blended with the polyamides and subsequently ground, the shaped bodies obtained by laser sintering in some cases show defects. It is assumed that these defects are caused by insufficient wetting of the fibrous reinforcement agent with the polyamides during the laser sintering process. Moreover, during the grinding in the mill, in some cases, a significant amount of the fibrous reinforcement agent is lost. The loss of the fibrous reinforcement agent after the grinding process is due to the separation of fines from the polymer powder. Due to the separation of fines, reinforcement fiber fragments are also removed from the polymer powder. Moreover, in some cases, it is difficult to precisely control the particle morphology of the sinter powder particles.

It is thus an object of the present invention to provide a process for the production of sinter powder particles (SP), which has the aforementioned disadvantages of the processes described in the prior art only to a lesser degree, if at all. The process shall be simple and inexpensive to perform.

This object is achieved by a process for the production of sinter powder particles (SP), comprising the steps

a) providing at least one continuous filament,
b) coating, the at least one continuous filament provided in step a) with at least one thermoplastic polymer to obtain a continuous strand comprising the at least one continuous filament, coated with the at least one thermoplastic polymer, wherein the average cross-sectional diameter of the strand is in the range of 10 to 300 μm, and
c) size reducing of the continuous strand provided in step b) in order to obtain the sinter powder particles (SP), wherein the average length of the sinter powder particles (SP) is in the range of 10 to 300 μm.

It has been found that, surprisingly, the sinter powder particles (SP) obtained by the inventive process, if used in a powder-based additive manufacturing process, lead to shaped bodies which have improved mechanical properties. Moreover, it has been found that the inventive process leads to sinter powder particles (SP) which have a quite uniform shape. Furthermore, the process for the production of the sinter powder particles (SP) is simple and can be performed in a cost-efficient way.

### Step a)

In step a) at least one continuous filament is provided. In the context of the present invention a “continuous filament” is a fiber material with a length of at least 1 000 meters, preferably at least 10 000 meters. In a particularly preferred embodiment in the context of the present invention a “continuous filament” is a practically endless fiber as defined in DIN 60001 T2 (December 1974).

Continuous filaments are known in the state of the art. Continuous filaments are typically produced in a spinning process. In step a) the at least one continuous filament can be provided in any suitable way. The at least one continuous filament generally can be unwound from rolls. In another embodiment the at least one continuous filament can be withdrawn directly from the spinning process. It is also possible to provide the at least one continuous filament in form of a fiber roving, braided fibers, and woven fibers from which the at least one continuous filament is separated. In one embodiment the at least one continuous filament is covered with a sizing to improve the adhesion between the at least one filament and the at least one thermoplastic polymer. Suitable sizings may be selected from the group consisting of water based polymer dispersions containing ethylenvinylacetate polymers, polyester polymers, epoxy resins, silanes (e. g. aminosilanes) and/or polyurethane polymers.

In a preferred embodiment, the at least one continuous filament is selected from the group consisting of continuous carbon fibers, continuous boron fibers, continuous glass fibers, continuous silica fibers, continuous basalt fibers and continuous aramid fibers. In a more preferred embodiment, the at least one continuous filament is selected from the group consisting of continuous carbon fibers, continuous glass fibers and continuous aramid fibers. In an even more preferred embodiment, the at least one continuous filament is selected from the group consisting of continuous carbon fibers and continuous glass fibers.

Therefore, another object of the present invention is a process wherein the continuous filament is selected from the group consisting of continuous carbon fibers, continuous boron fibers, continuous glass fibers, continuous silica fibers, continuous basalt fibers and continuous aramid fibers.

The cross-sectional diameter of the at least one continuous filament is generally in the range of 3 to 30 μm, preferably in the range of 4 to 25 μm, more preferably in the range of 5 to 20 μm, and particularly preferred in the range of 6 to 18 μm. The cross-sectional diameter is measured orthogonal to the longitudinal axis of the at least one continuous filament.

Therefore, another object of the present invention is a process wherein the cross-sectional diameter of the continuous filament is in the range of 3 to 30 μm.

According to the present invention, “at least one continuous filament” means either exactly one continuous filament or two or more continuous filaments. The number of continuous filaments provided in step a) firstly depends on the cross-sectional diameter of the continuous filament, and secondly on the cross-sectional diameter of the strand obtained in step b). The number of continuous filaments provided in step a) is limited by the size of a continuous strand. The volume of all continuous filaments provided in step a) must not exceed the volume of the continuous strand obtained in step b). Generally, the total volume of all continuous filaments provided in step a) is at most 90 vol.-%, preferably at most 70 vol.-% and particularly preferred at most 50 vol.-%, in each case referred to the total volume of the continuous strand obtained in step b). Preferably, the total volume of the continuous filaments provided in step a) is at least 10 vol.-%, preferably 20 vol.-% and especially preferred at least 30 vol.-%, in each case referred to the total volume of the continuous strand contained in step b).

By way of example, if the continuous filament has a cross-sectional diameter of 3 μm and the strand obtained in step b) has a cross-sectional diameter of 10 μm in step a), at most three continuous filaments, preferably two continuous filaments, and more preferably only one continuous filament is provided in step a). If the cross-sectional diameter of the continuous filament is, for example, 10 μm, and the cross-sectional diameter of the strand obtained in step b) is 300 μm, preferably at most 25, more preferably at most 20 and particularly preferred at most 10 continuous filaments are provided in step a).

Generally, in step a), 1 to 50, more preferably 1 to 30, even more preferably 1 to 25 and particularly preferred 1 to 20 continuous filaments are provided.

### Step b)

In step b), the at least one continuous filament provided in step a) is coated with at least one thermoplastic polymer in order to obtain a continuous strand comprising the at least one continuous filament which is coated with the at least one thermoplastic polymer.

In step b), all known thermoplastic polymers may be used. Suitable thermoplastic polymers may be amorphous thermoplastic polymers or semicrystalline thermoplastic polymers. Semicrystalline thermoplastic polymers have a melting point. Amorphous thermoplastic polymers do not have a melting point but have a softening point. Semicrystalline thermoplastic polyamines are preferred.

If a semicrystalline thermoplastic polymer is used step b) is generally carried out at a temperature in the range from 10 to 100° C., more preferably 20 to 80° C. and particularly preferred 30 to 70° C. above the melting point of the at least one semicrystalline thermoplastic polymer. If a mixture of semicrystalline thermoplastic polymers is used, step b) is carried out at the above mentioned temperature ranges, wherein the highest melting point of the semicrystalline thermoplastic polymer in the polymer mixture is used as a reference.

If an amorphous thermoplastic polymer is used, step b) is generally carried out at a temperature in the range from 50 to 200° C., more preferably 70 to 150° C. and particularly preferred 90 to 130° C. above the glass transition temperature (T_{G}) of the at least one amorphous thermoplastic polymer. If a mixture of amorphous thermoplastic polymers is used, step b) is carried out at the above mentioned temperature ranges, wherein the highest glass transition temperature (T_{G}) of the amorphous thermoplastic polymer in the polymer mixture is used as a reference.

If a mixture of semicrystalline thermoplastic polymers and amorphous thermoplastic polymers are used step b) is carried out at the above mentioned temperature ranges, wherein the highest melting point of the semicrystalline thermoplastic polymer in the polymer mixture is used as a reference.

In a preferred embodiment step b) is carried out at a temperature in the range from 30 to 400° C., more preferably 100 to 350° C. and particularly preferred 200 to 350° C.

In other words, in step b), the at least one continuous filament provided in step a) is contacted with a melt of the at least one thermoplastic polymer in order to coat the at least one filament. This process is also named “wetting”. In a preferred embodiment the melt of the at least one thermoplastic polymer has a temperature as defined above for the temperature ranges at which step b) is carried out.

The coating according to step b) can be carried out in any suitable apparatus. Preferably, step b) is carried out in an open or in a closed die, wherein a closed die is preferred. In an even more preferred embodiment, step b) is carried out in a pultrusion apparatus. In other words, step b) is carried out as a pultrusion process, wherein the strand obtained in step b) is conveyed out of the closed die by means of a conveying unit. The conveying unit preferably conveys the strand to the size reducing apparatus used in step c).

In order to coat the at least one continuous filament in step b), in a preferred embodiment, the at least one continuous filament and the at least one thermoplastic polymer are simultaneously conveyed through the preferred closed die.

Subsequently, after exiting the die the strand is generally cooled so that the melt of the thermoplastic polymer can solidify in order to obtain the continuous strand comprising the at least one continuous filament coated with the at least one thermoplastic polymer having a cross-dimensional diameter in the range of 10 to 300 μm. The cross-sectional diameter is measured orthogonal to the longitudinal axis of the continuous strand at a temperature of 23° C.

In a preferred the continuous strand has a cross-dimensional diameter in the range from 10 to 300 μm, more preferably 20 to 200 μm and particularly preferred 30 to 150 μm.

The strand (also named “pultrudate”) is drawn (conveyed) off the die generally at a speed of more than 1 m/min. The take-off speed is particularly preferred more than 1.5 m/min and in particular preferred more than 0.2 m/min. The maximum speed preferably is at most 100 m/min.

According to the invention, “at least one thermoplastic polymer” means either exactly one thermoplastic polymer or a mixture of two or more thermoplastic polymers.

Suitable thermoplastic crystalline polymers are selected from the group consisting of polyamides, polyethylenes, polypropylenes, polyether ketones, polyoxymethylenes, polyphenylenesulfides, polyesters, copolymers thereof, and combinations thereof.

The melting point and the glass transition temperature is measured with differential scanning calorimetry (DSC), wherein a heating rate at 10 K/min is used and wherein the melting point and the glass transition temperature (T_{G}) are determined in the second heating run.

Therefore, another object of the present invention is a a process wherein in step c) the strand obtained in step b) is cut to a length in the range of 10 to 300 μm.

Suitable polyethylenes include low-density polyethylene, medium-density polyethylene, high-density polyethylene and combinations thereof. Suitable polypropylenes include isotactic isopropylenes, syndiotactic polypropylenes, branched and linear variations thereof and combinations thereof, and polypropylene copolymers.

Suitable polyesters include polyethylene terephthalate esters and polybutylene terephthalate esters.

Suitable thermoplastic amorphous polymers are selected from the group consisting of polystyrene, polysulfones (PSU), polyethersulfones (PESU), polyphenylene ether sulfones (PPSU), PA 6I/T, PA 6/3T, polycarbonates, polystyrol acryl nitriles, polybutadienes and poly(methylmethacrylates) (PMMA).

In a preferred embodiment, the at least one thermoplastic polymer is selected from the group consisting of polyamide polymers.

For example the following polyamides are suitable to be used as at least one thermoplastic polyamide polymer:

### AB Polymers:

PA 4 pyrrolidone
PA 6 ε-caprolactam
PA 7 enantholactam
PA 8 caprylolactam
PA 11 undecanlactam
PA 12 laurinlactam
AA/BB polymers:
PA 46 tetramethylenediamine, adipic acid
PA 66 hexamethylenediamine, adipic acid
PA 69 hexamethylenediamine, azelaic acid
PA 610 hexamethylenediamine, sebacic acid
PA 612 hexamethylenediamine, decanedicarboxylic acid
PA 613 hexamethylenediamine, undecanedicarboxylic acid
PA 6T hexamethylenediamine, terephthalic acid
PA 9T nonanediamine, terephtalic acid
PA MXD6 m-xylylenediamine, adipic acid
PA 6I/6T (hexamethylenediamine, isophthalic acid, terephthalic acid)
PA 6T/6I (hexamethylenediamine, terephthalic acid, isophthalic acid)
PA 6/6I (see PA 6), hexamethylenediamine, isophthalic acid

### PA 6/6T (see PA 6 and PA 6T)

PA 6/3T (see PA 6), therephthalic acid and propylenediamine

### PA 6/66 (see PA 6 and PA 66)

PA 6/12 (see PA 6), laurylolactam

### PA 66/6/610 (see PA 66, PA 6 and PA 610)

PA 6I/6T/PACM as PA 6I/6T and diaminodicyclohexylmethane
PA 6/6I6T (see PA 6 and PA 6T), hexamethylenediamine, isophthalic acid

Preferably, the at least one thermoplastic polymer is selected from the group consisting of PA 4, PA 6, PA 7, PA 8, PA 11, PA 12, PA 46, PA 66, PA 69, PA 610, PA 612, PA 613, PA 6T, PA MXD6, PA 6I/6T, PA 6T/6I, PA 6/6I, PA 6/6T, PA 6/66, PA 6/12, PA 66/6/610, PA 6I/6T/PACM, and PA 6/6I6T and mixtures thereof.

Preferably, the at least one thermoplastic polymer is therefore selected from the group consisting of PA 6, PA 6I/6T, PA 6.6, PA 6.10, PA 6.12, PA 6.36, PA 6/6.6, PA 6/6I6T, PA 6/6T and PA 6/6I and mixtures thereof.

Especially preferably, the at least one thermoplastic polymer is selected from the group consisting of PA 6, PA 6I/6T, PA 6.10, PA 6.6/6, PA 6/6T and PA 6.6. More preferably, the at least one thermoplastic polymer is selected from the group consisting of PA 6 and PA 6/6.6. Most preferably, the at least one thermoplastic polymer is PA 6, PA 6I/6T and mixtures thereof.

The present invention therefore also provides a process in which the at least one thermoplastic polymer is selected from the group consisting of PA 6, PA 6I/6T PA 6.6, PA 6.10, PA 6.12, PA 6.36, PA 6/6.6, PA 6/6I6T, PA 6/6T and PA 6/6I and mixtures thereof.

The at least one thermoplastic polymer generally has a viscosity number of 70 to 350 mL/g, preferably of 70 to 240 mL/g. According to the invention, the viscosity number is determined from a 0.5% by weight solution of component (A) and in 96% by weight sulfuric acid at 25° C. to ISO 307.

The at least one thermoplastic polymer preferably has a weight-average molecular weight (M_{W}) in the range from 500 to 2 000 000 g/mol, more preferably in the range from 5000 to 500 000 g/mol and especially preferably in the range from 10 000 to 100 000 g/mol. The weight-average molecular weight (M_{W}) is determined according to ASTM D4001.

The at least one thermoplastic polymer may comprise at least one additive. Suitable additives are known to those skilled in the art. Suitable additives are, for example, selected from the group of antinucleating agent, stabilizers, end group functionalizers and dyes.

### Step c)

In step c), the size of the continuous strand provided in step b) is reduced in order to obtain the sinter powder particles (SP).

The size reducing step c) may be carried out by grinding, crushing, fracturing or cutting. Preferably, the size reducing in step c) is carried out by cutting.

Therefore, another object of the present invention is a process wherein in step c) the strand obtained in step b) is cut to a length in the range of 10 to 300 μm.

Before the size reducing step c) is carried out, the continuous strand obtained in step b) in one embodiment is aggregated to a roving which contains a plurality of continuous strands.

The roving may contain up to 50 000, preferably up to 25 000, more preferably up to 20 000 continuous strands. Preferably, the roving contains at least 50, more preferred at least 100, even more preferred at least 1 000 and particularly preferred at least 5 000 continuous strands.

In this embodiment, the roving containing the plurality of continuous strands is conveyed to a cutting apparatus, wherein the size reducing step c) is carried out. If a single continuous strand is transported to the cutting apparatus, with each cutting one sinter powder particle (SP) is obtained. If a roving containing a plurality of continuous strands is transported to the cutting apparatus, with each cut a plurality of sinter powder particles (SP) is obtained, wherein the number of sinter powder particles (SP) obtained in each cutting step equals the number of continuous strands contained in the roving.

Preferably, in step c), the strand obtained in step b), preferably in the form of a roving, is cut to a length in the range of 10 to 300 μm.

The sinter powder particles (SP) have generally an essentially cylindrical shape. The cross-sectional diameter of the sinter powder particles (SP) equals the cross-sectional diameter of the strand obtained in step b). The cross-sectional diameter of the sinter powder particles is measured orthogonal to the longitudinal axis of the sinter powder particles (SP) having an essentially cylindrical shape.

Therefore, another object is a sinter powder having an essentially cylindrical shape, having an average cross-sectional diameter in the range of 10 to 300 μm, and having a average length in the range of 10 to 300 μm, comprising at least one reinforcement fiber in the core of the essentially cylindrical particle and a coating of at least one thermoplastic polymer which forms the lateral surface of the cylindrical particle.

The average ratio between the average length of the sinter powder length (SP) and the average cross-sectional diameter of the sinter powder particles (SP) is generally in the range from 1:1 to 30:1, preferably in the range of 1:1 to 25:1, more preferably in the range of 5:1 to 20:1.

Therefore, another object of the present invention is a process wherein the average ratio between the average length of the sinter powder particles (SP) and the average cross-sectional diameter of the sinter powder particles (SP) is in the range from 1:2 to 30:1.

In a preferred embodiment, at least 70%, more preferred 80%, even more preferred 90% and particularly preferred 95% of the sinter powder particles (SP) have an essentially cylindrical shape, in each case referred to the total amount of the particles (SP).

Therefore, another object of the present invention is a process wherein at least 70% of the sinter powder particles (SP) have an essentially cylindrical shape.

The term “essentially cylindrical shape” according to the present invention preferably means that the shape of the sinter powder particles has essentially the shape of any three-dimensionally cylinder by the way of example a right cylinder or an oblique cylinder. The base of the essentially cylindrical sinter powder particles may be a polygon, a circle, an ellipse or a triangle.

In another preferred embodiment, the term “essentially cylindrical shape” may be defined as follows: “Essentially cylindrical shape” defines that the sinter powder particles (SP) occupy at least 60%, preferred at least 70%, more preferred at least 80%, and particularly preferred 90% of the interior volume of a hypothetical best fit cylindrical shape in which the sinter powder particles (SP) fit.

Another object of the present invention are sinter powder particles (SP) obtained by the process described above. The sinter powder particles (SP) can be used in a powder-based additive manufacturing process. Preferred additive manufacturing processes are selected from the group consisting of selective laser sintering, selective inhibition sintering and high-speed sintering. Preferably the sinter powder particles (SP) are used in selective laser sintering and in high-speed sintering.

Another object of the present invention are sinter powder particles (SP) having an essentially cylindrical shape, having an average cross-sectional diameter in the range of 10 to 300 μm, and having an average length in the range of 10 to 300 μm, comprising at least one continuous filament in the core of the essentially cylindrical particle and a coating of at least one thermoplastic polymer which forms the lateral surface of the cylindrical particle. For the above-mentioned sinter powder particles (SP), the aforementioned descriptions and preferences for the process for the production of the sinter powder particles (SP) apply accordingly.

The sinter powder particles (SP) can be mixed with other sinter powder particles which are different from the sinter powder particles (SP). Therefore, another object of the present invention is a sinter powder comprising 10 to 90% by weight of the sinter powder particles (SP), and 90 to 10% by weight of other sinter powder particles which are different from the sinter powder particles (SP), based on the total weight of the sinter powder.

The other sinter powder particles can be formed by the above described process for the production of sinter powder particles, wherein different thermoplastic polymers or different continuous filaments are used. Preferably, the other sinter powder particles, however, are selected from sinter powder particles which are produced by conventional methods like grinding or precipitation. In a preferred embodiment, the other sinter powder particles do not contain a reinforcement agent.

As mentioned above, the shaped bodies obtained by laser sintering or high-speed sintering of the sinter powder particles (SP) or the sinter powders which contain a mixture of the sinter powder particles (SP) with other sinter powder particles show improved mechanical properties. Therefore, another object of the present invention is a process for the production of a shaped body by laser sintering or high-speed sintering of sinter powder particles (SP)

Another object of the present invention is a process for the production of shaped bodies by selective laser sintering or high-speed sintering of a sinter powder.

The average cross-sectional diameter of the sinter powder particles is determined via light microscope. Therefore, randomly 100 samples are measured via light microscope to determine the average cross-sectional diameter. The average length of the sinter powder particles is determined respectively.

1. A process for the production of sinter powder particles (SP), comprising the steps
a) providing at least one continuous filament,
b) coating, the at least one continuous filament provided in step a) with at least one thermoplastic polymer to obtain a continuous strand comprising the at least one continuous filament, coated with the at least one thermoplastic polymer, wherein the average cross-sectional diameter of the strand is in the range of 10 to 300 μm, and
c) size reducing of the continuous strand provided in step b) in order to obtain the sinter powder particles (SP), wherein the average length of the sinter powder particles (SP) is in the range of 10 to 300 μm.

2. A process according to claim 1, wherein the cross-sectional diameter of the continuous filament is in the range of 3 to 30 μm.

3. A process according to claim 1 or 2, wherein the continuous filament is selected from the group consisting of continuous carbon fibers, continuous boron fibers, continuous glass fibers, continuous silica fibers, continuous basalt fibers and continuous aramid fibers.

4. A process according to any of claims 1 to 3, wherein the average ratio between the average length of the sinter powder particles (SP) and the average cross-sectional diameter of the sinter powder particles (SP) is in the range from 1:2 to 10:1.

5. A process according to any of claims 1 to 4, wherein in step c) the strand obtained in step b) is cut to a length in the range of 10 to 300 μm.

6. A process according to any of claims 1 to 5, wherein the at least one thermoplastic polymer is selected from the group consisting of polyamides, polyethylenes, polypropylenes, polyether ketones, polyoxymethylenes, polytetrafluorethylenes, polyphenylenesulfides, polyesters, copolymers thereof, and combinations thereof.

7. A process according to any of claims 1 to 6, wherein at least 70% of the sinter powder particles (SP) have an essentially cylindrical shape.

8. A process according to any of claims 1 to 7, wherein the at least one polymer is selected from the group consisting of polyamide polymers.

9. A process according to any of claims 1 to 8, wherein the at least one thermoplastic polymer is selected from the group consisting of PA 4, PA 6, PA 7, PA 8, PA 11, PA 12, PA 46, PA 66, PA 69, PA 610, PA 612, PA 613, PA 6T, PA MXD6, PA 6I/16T, PA 6T/6I, PA 6/6I, PA 6/6T, PA 6/66, PA 6/12, PA 66/6/610, PA 6I/6T/PACM, and PA 6/6I6T and mixtures thereof.

10. Sinter powder particles (SP) obtained by a process according to any of claims 1 to 9.

11. Use of the sinter powder particles (SP) according to claim 10 in a powder-based additive manufacturing process, selected from the group consisting of selective laser sintering, selective inhibition sintering and high-speed sintering.

12. Sinter powder particles (SP) having an essentially cylindrical shape, having an average cross-sectional diameter in the range of 10 to 300 μm, and having a average length in the range of 10 to 300 μm, comprising at least one reinforcement fiber in the core of the essentially cylindrical particle and a coating of at least one thermoplastic polymer which forms the lateral surface of the cylindrical particle.

13. A sinter powder comprising 10 to 90% by weight of the sinter powder particles (SP) according to claim 10 or claims 12, and 90 to 10% by weight of other sinter powder particles which are different from the sinter powder particles (SP), based on the total weight of the sinter powder.

14. A process for the production of a shaped body by laser sintering or high-speed sintering of sinter powder particles (SP) according to claim 9 or 12.

15. A process for the production of a shaped body by selective laser sintering or high-speed sintering of a sinter powder according to claim 13.
